(19) United States
(12) Patent Application Publication
(10) Pub. No.: US 2023/0318029 A1
(43) Pub. Date: Oct. 5, 2023

(54) SOLID-STATE BATTERY AND METHOD OF MANUFACTURING SOLID ELECTROLYTE SHEET

(71) Applicant: HONDA MOTOR CO., LTD., Tokyo (JP)

(72) Inventors: Akihiro YOSHIZAWA, Saitama (JP); Yohei NOJI, Saitama (JP)

(21) Appl. No.: 18/190,133

(22) Filed: Mar. 27, 2023

(30) Foreign Application Priority Data
Mar. 31, 2022 (JP) 2022-058867

(51) Int. Cl. H01M 10/0562; H01M 10/0585; H01M 4/134; H01M 4/38

(52) U.S. Cl. CPC H01M 10/0562; H01M 4/134; H01M 4/382; H01M 4/386; H01M 10/0585; H01M 2004/027

(57) ABSTRACT

A solid-state battery includes: a positive electrode 10, a negative electrode 20, and a solid electrolyte layer 30 disposed between the positive and negative electrodes 10, 20 and which includes a solid electrolyte sheet 31 containing a porous base material 33 filled with a solid electrolyte material, and a binder 40, wherein the solid electrolyte layer 30 includes a positive electrode-side region 34 including a region distanced from a contact surface with the positive electrode 10, a negative electrode-side region 35 including a region distanced from a contact surface with the negative electrode 20, and an intermediate region 36 between the regions 34 and 35, a higher percentage of the base material 33 is disposed in the intermediate region 36 than in the regions 34, 35, and content of the binder in the intermediate region 36 is higher than that in at least one selected from the regions 34, 35.

This application is based on and claims the benefit of priority from Japanese Patent Application No. 2022-058867, filed on March 31,2022.

### BACKGROUND OF THE INVENTION

### Field of the Invention

The present invention relates to a solid-state battery and a method of manufacturing a solid electrolyte sheet.

### Related Art

In recent years, secondary batteries that can be charged and discharged repeatedly, as typified by lithium-ion batteries, have come into widespread use. Secondary batteries of this type use an electric field solution such as an organic solvent as the ion transfer medium, and thus are problematic in view of leakage of the electrolytic solution, safety with respect to heat, and the like. Accordingly, solid-state batteries using an inorganic solid electrolyte instead of an organic electrolyte are being proposed and developed.

Ordinarily, a solid-state battery has a structure in which a solid electrolyte layer is interposed between a positive electrode and a negative electrode. For example, a solid electrolyte layer of a lithium-ion solid-state battery functions to conduct lithium ions and functions as a separator that prevents shorting between a positive electrode active material layer in the positive electrode and a negative electrode active material layer in the negative electrode. To improve the energy density, the solid electrolyte layer serving as the separator is preferably as thin as possible. However, since simply making the layer thinner may cause cracks or the like to occur due to reduced strength, a solid-state battery is known in which a base material is included to attain a thinner and reinforced solid electrolyte layer (see Japanese Unexamined Patent Application, Publication No.2015-153460, for instance).

Patent Document 1: Japanese Unexamined Patent Application, Publication No.2015-153460.

### SUMMARY OF THE INVENTION

Although the inclusion of a base material results in an improvement in the strength of the solid electrolyte layer, there are concerns that cracks may occur in the solid electrolyte layer if the strength is uneven. Moreover, there is a possibility that lithium ion conductivity may be insufficient due to delamination between the base material and the solid electrolyte or the occurrence of cracks described above.

A main objective of the present invention is to provide a solid-state battery with which both an improvement in the strength of a solid electrolyte layer including a base material and an improvement in ion conductivity can be attained.
(1) The present invention is a solid-state battery provided with: a positive electrode; a negative electrode; and a solid electrolyte layer which is disposed between the positive electrode and the negative electrode and which includes a solid electrolyte sheet containing a porous base material filled with a solid electrolyte material, and a binder, wherein the solid electrolyte layer includes a positive electrode-side region that includes : a region a prescribed distance from a contact surface with respect to the positive electrode, a negative electrode-side region that includes a region a prescribed distance from a contact surface with respect to the negative electrode, and an intermediate region located between the positive electrode-side region and the negative electrode-side region, a higher percentage of the base material is disposed in the intermediate region than in the positive electrode-side region and negative electrode-side region, and content of the binder in the intermediate region is higher than content of the binder in at least one selected from the positive electrode-side region and the negative electrode-side region.
(2) Preferably, content of the binder in the negative electrode-side region is higher than content of the binder in the positive electrode-side region.
(3) Preferably, the negative electrode includes a negative electrode layer containing a negative electrode active material disposed on a side of the solid electrolyte layer and a negative electrode current collector disposed on a surface side of the negative electrode, the negative electrode-side region includes a first negative electrode-side region located on a side of the negative electrode current collector and a second negative electrode-side region located closer to the positive electrode than the first negative electrode-side region, and content of the binder in the first negative electrode-side region is higher than content of the binder in the second negative electrode-side region.
(4) Preferably, when 100% by mass is taken to mean an entirety of the solid electrolyte layer, content of the binder for binding together the solid electrolyte material in the solid electrolyte layer is equal to or higher than 10% by mass.
(5) Preferably, the negative electrode includes, as the negative electrode active material, at least one selected from a Li-based material and a Si-based material.
(6) A method of manufacturing a solid electrolyte sheet according to the present invention is a method of manufacturing a solid electrolyte sheet containing a porous base material filled with a solid electrolyte material, and a binder, the method including: a first application step of applying the binder to the base material; and a second application step of applying the solid electrolyte material to the base material.
(7) Preferably, the first application step includes a step of applying to the base material a first solution containing the binder, and the second application step includes a step of applying to the base material a second solution which contains at least a solid electrolyte and which has a lower content of the binder than the first solution.

According to the present invention, it is possible to provide a solid-state battery with which both an improvement in the strength of a solid electrolyte layer including a base material and an improvement in ion conductivity can be attained.

### BRIEF DESCRIPTION OF THE DRAWINGS

FIG. 1 is a cross section that schematically illustrates a configuration of a solid-state battery according to an embodiment;

FIG. 2 is a perspective view that schematically illustrates a structure of a solid electrolyte layer according to the embodiment;

FIG. 3 is a cross section that schematically illustrates a layer configuration of the solid electrolyte layer according to the embodiment;

FIG. 4A is an enlarged cross section that illustrates a base material in a solid electrolyte layer and the solid electrolyte around the base material according to the embodiment;

FIG. 4B is a cross section of a solid electrolyte layer of the related art corresponding to FIG. 4A, and illustrates a state in which cracks occur because of the base material;

FIG. 5 is an example of charge-discharge curves of a solid-state battery according to the embodiment; and

FIG. 6 is a graph illustrating measurement results of the initial resistance of solid-state batteries according to a practical example and a comparative example.

### DETAILED DESCRIPTION OF THE INVENTION

Hereinafter, an embodiment of the present invention will be described.

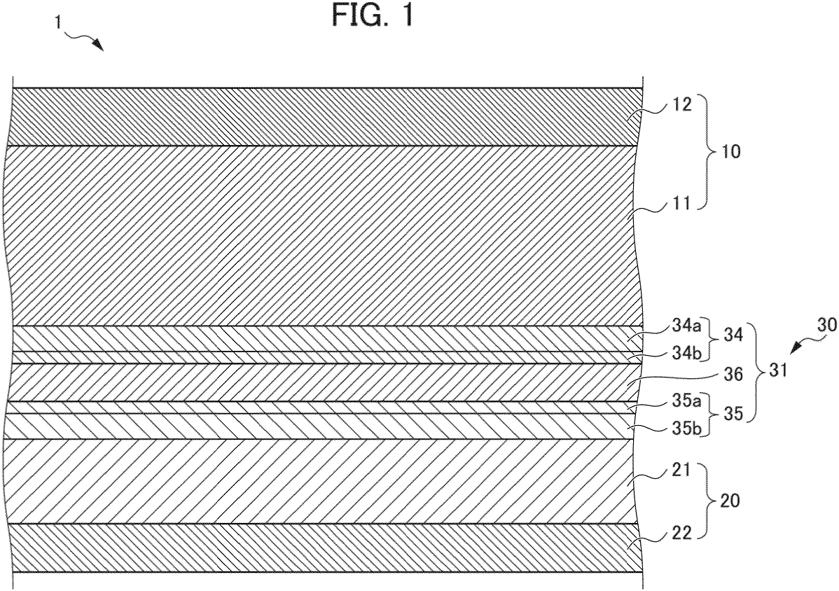

FIG. 1 is a cross section of a solid-state battery 1 according to the embodiment. As illustrated in FIG. 1, the solid-state battery 1 is provided with a positive electrode 10, a negative electrode 20, and a solid electrolyte layer 30. The solid-state battery 1 is a laminate in which the positive electrode 10, the solid electrolyte layer 30, and the negative electrode 20 are layered, in that order. The solid-state battery 1 of the embodiment is a lithium-ion solid-state battery. Note that the solid-state battery in this specification refers to a battery that is entirely solid-state.

The positive electrode 10 includes a positive electrode layer 11 and a positive electrode current collector 12. The positive electrode layer 11 is disposed on the solid electrolyte layer 30 side. The positive electrode current collector 12 forms the surface of the solid-state battery 1 on the positive electrode 10 side.

The positive electrode layer 11 includes a positive electrode active material. The positive electrode active material used in the positive electrode layer 11 is not particularly limited, and may be any material that would function as the positive electrode of the solid-state battery 1. Note that specific examples of the positive electrode active material include, among sulfides, titanium sulfide (TiS₂), molybdenum sulfide (MoS₂), iron sulfide (FeS, FeS₂), copper sulfide (CuS), and nickel sulfide (Ni₃S₂). Also, specific examples include, among oxides, bismuth oxide (Bi₂O₃), bismuth plumbate (Bi₂Pb₂O₅), copper oxide (CuO), vanadium oxide (V₆O₁₃), lithium cobalt oxide (LiCoO₂), lithium nickel oxide (LiNiO₂), lithium manganate (LiMnO₂), Li(NiCoMn)O₂, Li(NiCoAl)O₂, and Li(NiCo)O₂. Moreover, it is also possible to use a mixture of the above.

The positive electrode current collector 12 functions to collect current for the positive electrode layer 11. The positive electrode current collector 12 is a foil-like member containing a conductive electrode material. The electrode material used in the positive electrode current collector 12 is not particularly limited insofar as the material is conductive, and examples thereof include vanadium, aluminum, stainless steel, gold, platinum, manganese, iron, and titanium. Among these, aluminum is particularly preferable. The shape and thickness of the positive electrode current collector 12 are not particularly limited as long as current for the positive electrode layer 11 can be collected.

The negative electrode 20 includes a negative electrode layer 21 and a negative electrode current collector 22. The negative electrode layer 21 is disposed on the solid electrolyte layer 30 side. The negative electrode current collector 22 forms the surface of the solid-state battery 1 on the negative electrode 20 side.

The negative electrode layer 21 includes a negative electrode active material. The negative electrode active material used in the negative electrode layer 21 is not particularly limited, and may be any material that would function as the negative electrode of the solid-state battery 1, but the inclusion of at least one selected from a Li-based material and a Si-based material is preferable. Note that specific examples of the negative electrode active material include carbon materials, specifically, artificial graphite, graphite carbon fiber, resin-fired carbon, vapor-deposited pyrolytic carbon, coke, mesocarbon microbeads (MCMB), furfuryl alcohol resin-fired carbon, polyacene, pitch-based carbon fiber, vapor-deposited carbon fiber, natural graphite, and non-graphitizable carbon. A mixture of the above is also possible. Other examples include metals themselves, such as lithium metal, indium metal, aluminum metal, or silicon metal, or alloys combining these metals with other elements or compounds.

The negative electrode current collector 22 functions to collect current for the negative electrode layer 21. The negative electrode current collector 22 is a foil-like member containing a conductive electrode material. The electrode material used in the negative electrode current collector 22 is not particularly limited insofar as the material is conductive, and examples thereof include vanadium, stainless steel, manganese, iron, titanium, copper, nickel, cobalt, and zinc. Among these, copper and nickel are particularly preferable for their excellent conductivity and excellent current collection properties. The shape and thickness of the negative electrode current collector 22 are not particularly limited as long as current for the negative electrode layer 21 can be collected.

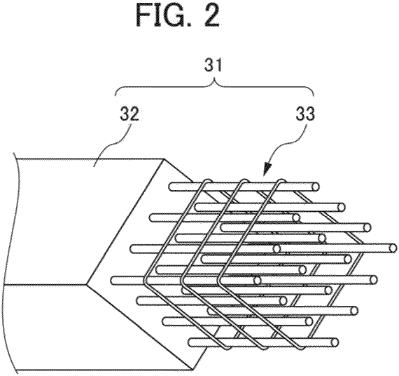

The solid electrolyte layer 30 includes a solid electrolyte sheet 31. The solid electrolyte sheet 31 is a sheet-like, porous base material filled with a solid electrolyte. As illustrated in FIG. 2, the solid electrolyte sheet 31 includes a solid electrolyte 32, a porous base material 33 placed in the solid electrolyte 32, and a binder, not illustrated, that is mixed into the solid electrolyte 32. The solid electrolyte 32 includes portions formed by solid electrolyte materials being bound together by the binder. The solid electrolyte 32 may also have a portion that does not include the binder. The solid electrolyte layer 30 including the solid electrolyte sheet 31 is disposed between the positive electrode 10 and the negative electrode 20.

The porous base material 33 preferably is a woven or non-woven fabric. A woven or non-woven fabric has a suitable porosity and thickness, and is easily filled with the solid electrolyte 32. The material of the base material 33 is not particularly limited, and may be any material with which a self-supporting sheet can be formed. Examples include polyethylene terephthalate, nylon, aramid, Al₂O₃, and glass. Additionally, the base material 33 preferably is formed from heat-resistant fiber. By forming the base material 33 from heat-resistant fiber, shorting can be suppressed in the manufacturing process and the like of the solid-state battery 1, even if pressing is performed at high temperatures exceeding 200° C., for example. Moreover, the solid electrolyte 32 can be sintered with a high-temperature press, and as a result, the interface resistance can be lowered and the output of the battery can be improved.

Note that, among heat-resistant fibers, the base material 33 forming the solid electrolyte sheet 31 of the present invention preferably is aramid fiber or Al₂O₃ fiber. In the case of aramid fiber or Al₂O₃ fiber, heat-induced deformation of the fiber is reduced.

The solid electrolyte material used in the solid electrolyte sheet 31 may be any material that allows for lithium ion conduction between the positive electrode 10 and the negative electrode 20, and is not particularly limited. Examples include oxide electrolytes and sulfide electrolytes. Note that the same material as the sulfide electrolyte used in the positive electrode layer 11 can be used as the solid electrolyte material used in the solid electrolyte sheet 31.

The solid electrolyte 32 of the solid electrolyte sheet 31 preferably includes a lithium element. Among these, a material containing at least lithium sulfide as a first component and synthesized from one or more compounds selected from the group consisting of silicon sulfide, phosphorus sulfide, and boron sulfide as a second component is preferable, with Li₂S-P₂S₅ being particularly preferable in view of lithium ion conductivity.

In the case in which the solid electrolyte 32 of the solid electrolyte sheet 31 is a sulfide electrolyte, a sulfide such as SiS₂, GeS₂, or B₂S₃ additionally may be included. Moreover, Li₃PO₄, halogen, a halogen compound, or the like may also be added to the solid electrolyte 32, as appropriate.

In the case in which the solid electrolyte 32 of the solid electrolyte sheet 31 is a lithium ion conductor formed from an inorganic compound, examples include Li₃N, LISICON, LIPON (Li_{3+y}PO₄₋ₓNₓ), Thio-LISICON (Li_{3.25}Ge_{0.25}P_{0.75}S₄), Li₂O-Al₂O₃-TiO₂-P₂O₅ (LATP).

The solid electrolyte 32 of the solid electrolyte sheet 31 may have an amorphous, vitreous, crystalline (crystallized glass), or other structure. In the case in which the solid electrolyte 32 is a sulfide solid electrolyte formed from Li₂S-P₂S₅, the lithium ion conductivity of an amorphous body is approximately 10⁻⁴ Scm⁻¹. On the other hand, the lithium ion conductivity in the case of a crystalline body is approximately 10⁻³ Scm⁻¹.

The solid electrolyte 32 of the solid electrolyte sheet 31 preferably includes at least one selected from phosphorus and sulfur. With this configuration, the ion conductivity of the obtained solid-state battery 1 can be improved.

As illustrated in FIG. 1, the solid electrolyte layer 30 including the solid electrolyte sheet 31 has a three-layer structure of a positive electrode-side region 34, a negative electrode-side region 35, and an intermediate region 36. The positive electrode-side region 34 is the region of the solid electrolyte layer 30 that includes the region a prescribed distance from the contact surface with respect to the positive electrode layer 11 of the positive electrode 10, and is disposed between the positive electrode layer 11 and the intermediate region 36. The negative electrode-side region 35 is the region of the solid electrolyte layer 30 that includes the region a prescribed distance from the contact surface with respect to the negative electrode layer 21 of the negative electrode 20, and is disposed between the negative electrode layer 21 and the intermediate region 36. The intermediate region 36 is located between the positive electrode-side region 34 and the negative electrode-side region 35 in the solid electrolyte layer 30. The layer thickness ratios of the positive electrode-side region 34, intermediate region 36, and negative electrode-side region 35 in the solid electrolyte layer 30 are set approximately such that the positive electrode-side region 34 is 10% to 33%, the intermediate region 36 is 34% to 80%, and the negative electrode-side region 35 is 10% to 33%, for example, but the ratios are not limited thereto.

In this case, a higher percentage of the porous base material 33 in the solid electrolyte sheet 31 is disposed in the intermediate region 36 than in the positive electrode-side region 34 and negative electrode-side region 35. Moreover, the binder content in the intermediate region 36 is higher than the binder content in at least one selected from the positive electrode-side region 34 and the negative electrode-side region 35. The binder content in the intermediate region 36 preferably is higher than the binder content in both of the positive electrode-side region 34 and the negative electrode-side region 35. Also, the binder content in the negative electrode-side region 35 preferably is higher than the binder content in the positive electrode-side region 34.

In the embodiment, the negative electrode-side region 35 of the solid electrolyte layer 30 further includes a first negative electrode-side region 35a located on the negative electrode current collector 22 side and a second negative electrode-side region 35b located closer to the positive electrode 10 side than the first negative electrode-side region 35a. Additionally, in a preferred mode, the binder content in the first negative electrode-side region 35a is higher than the binder content in the second negative electrode-side region 35b. Note that this configuration may also be applied to the positive electrode-side region 34.

That is, the positive electrode-side region 34 of the solid electrolyte layer 30 includes a first positive electrode-side region 34a located on the positive electrode current collector 12 side and a second positive electrode-side region 34b located closer to the negative electrode 20 side than the first positive electrode-side region 34a. Additionally, in a preferred mode, the binder content in the first positive electrode-side region 34a is higher than the binder content in the second positive electrode-side region 34b.

Also, in the embodiment, when 100% by mass is taken to mean the entirety of the solid electrolyte layer 30, the binder content for binding together the solid electrolyte material in the solid electrolyte layer 30 preferably is equal to or higher than 10% by mass.

The binder according to the embodiment can adhere to the surface of the base material 33 and to the solid electrolyte material. A binder containing, for example, an adhesive resin exhibiting adhesive properties is preferable. Examples of the solid electrolyte material include (meth)acrylic thermoplastic resin, silicone resin, urethane resin, nitrile resin, polyester resin, cellulose resin, styrene resin, styrene butadiene resin, vinyl acetate resin, fluoroethylene resin, polyvinyl ether, and rubber. Note that “(meth)acrylic” is used as a collective term referring to acrylic and methacrylic.

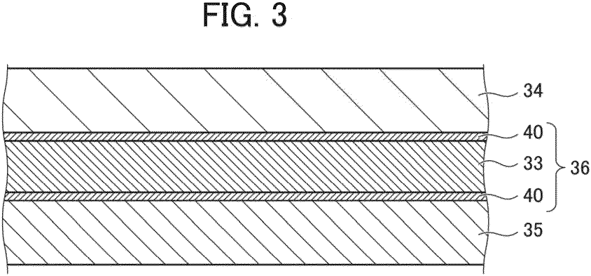

FIG. 3 is an enlarged cross section that schematically illustrates the solid electrolyte layer 30 including the solid electrolyte sheet 31. In FIG. 3, the sign 40 denotes the binder. In FIG. 3, as described above, the solid electrolyte layer 30 has a three-layer structure of the positive electrode-side region 34, the negative electrode-side region 35, and the intermediate region 36. Additionally, a higher percentage of the base material 33 is disposed in the intermediate region 36 than in the positive electrode-side region 34 and the negative electrode-side region 35. Furthermore, the binder 40 has a higher content in the intermediate region 36 than in both the positive electrode-side region 34 and the negative electrode-side region 35, and in this case is disposed to cover the perimeter of the base material 33 of the intermediate region 36. That is, much of the base material 33 is disposed midway in the thickness direction of the solid electrolyte layer 30, and much of the binder 40 is disposed on the perimeter of the base material 33. The quantity of the binder 40 in the positive electrode-side region 34 and the negative electrode-side region 35 near the surface layers of the solid electrolyte layer 30 is relatively small. In other words, the base material 33 is concentrated in the intermediate region 36, and much of the binder 40 surrounds the base material 33.

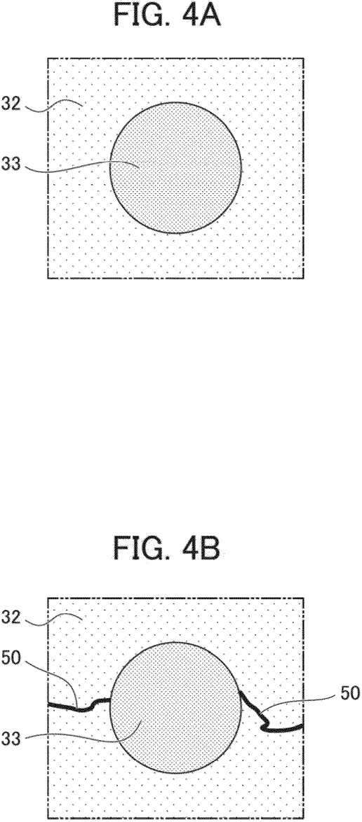

This arrangement improves the strength of the solid electrolyte layer 30 due to the inclusion of the base material 33, while also suppressing delamination and cracking between the solid electrolyte 32 and the base material 33 due to the inclusion of the base material 33, and reducing unevenness in the strength. FIG. 4A is an enlarged view that schematically illustrates the base material 33 disposed inside the solid electrolyte 32, in which much of the binder is included in the solid electrolyte 32 around the base material 33. In this case, cracks originating from the base material 33 do not occur, nor does the solid electrolyte 32 delaminate. In contrast, if there is a small quantity of binder in the solid electrolyte 32 around the base material 33 as illustrated in FIG. 4B, cracks 50 originating from the base material 33 occur, and there is a possibility of delamination originating from the cracks 50.

The solid electrolyte sheet 31 according to the embodiment described above can be manufactured according to a manufacturing method like the following.

### First Application Step

The binder is applied to the base material 33 formed from a non-woven fabric. The application of the binder involves applying to the base material 33 a first solution prepared to have a predetermined binder content. The method of applying the first solution to the base material 33 may be, for example, a method such as immersing the base material 33 into the first solution and then lifting up. Alternatively, the base material 33 may be placed on a flat plate and impregnated with the first solution applied thereto. Thereafter, the first solution may be dried to ensure that the binder in the first solution is retained on the surface of the base material 33.

### Second Application Step

A solid electrolyte material is applied to the base material 33 to which the first solution has been applied. The application of the solid electrolyte material involves mixing the solid electrolyte material and a binder into a slurry solution such as butyl acetate, and additionally applying to the base material 33 a second solution in which the amount of binder is adjusted so that the binder content is lower than that of the first solution. The second solution is the solid electrolyte slurry. The method of application may be similar to the first application step. Thereafter, the second solution is dried.

By the above, the solid electrolyte sheet 31 of the embodiment is obtained. Note that the solid electrolyte sheet 31 may be the dried sheet as-is, but may be further pressurized in a treatment to raise its strength and density. Examples of the pressurizing method include sheet pressing and roll pressing.

### Example

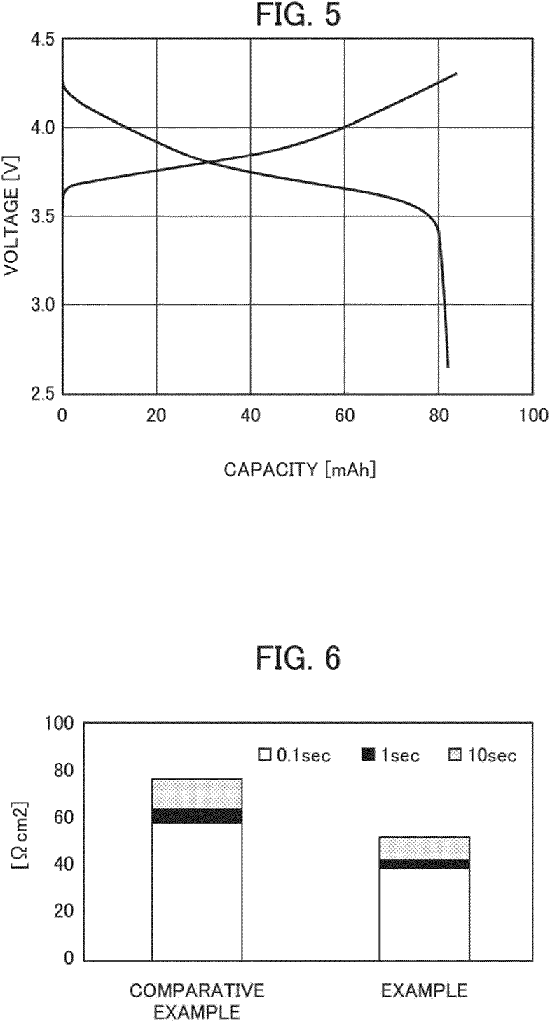

FIG. 5 is a graph illustrating an example of charge-discharge curves of the solid-state battery 1 according to the embodiment. As illustrated in FIG. 5, the charge-discharge curves take capacity (mAh) as the horizontal axis and voltage (V) as the vertical axis, and are derived on the basis of the current and voltage of the lithium-ion battery during charging and discharging.

Specifically, a solid-state battery was made by laminating sheet-like negative electrode - solid electrolyte sheet (solid electrolyte layer) - sheet-like positive electrode, and pressurizing the laminate in a press machine at a pressure of approximately 10 t/cm². At this time, the solid-state battery was prepared in a completely sealed state to avoid exposure to the atmosphere. For the base material of the solid electrolyte sheet, a non-woven fabric was used, the thickness of the solid electrolyte sheet was 30 µm, and the binder content in the solid electrolyte sheet was 10% by mass. Thereafter, upon charging and discharging in a 25° C. environment, both the specific capacity and charge-discharge efficiency were sufficient properties for a battery.

After performing the above discharge capacity measurement, the initial resistance value of the direct-current resistance at 0.5 C was measured. Measurements were taken in a 25° C. environment at 50% SOC and at energization times of 0.1 s, 1 s, and 10 s, and the initial resistance was measured for each energization time. Note that as a comparative example, a solid-state battery was prepared in which a base material was not included in the solid electrolyte sheet, the thickness of the solid electrolyte sheet was 100 µm, and the binder content of the solid electrolyte sheet was 3% by mass, and the initial resistance was measured under similar conditions. The measurement results for the initial resistance are illustrated in FIG. 6. As illustrated in FIG. 6, the solid-state battery of the example was confirmed to have an initial resistance approximately 35% lower than that of the comparative example outside the present invention.

The solid-state battery 1 according to the embodiment described above exhibits the following advantageous effects.

The solid-state battery 1 according to the embodiment is provided with: the positive electrode 10; the negative electrode 20; and the solid electrolyte layer 30 which is disposed between the positive electrode 10 and the negative electrode 20 and which includes the solid electrolyte sheet 31 containing the porous base material 33 filled with the solid electrolyte material, and the binder 40, wherein the solid electrolyte layer 30 includes the positive electrode-side region 34 that includes the region a prescribed distance from the contact surface with respect to the positive electrode 10, the negative electrode-side region 35 that includes the region a prescribed distance from the contact surface with respect to the negative electrode 20, and the intermediate region 36 located between the positive electrode-side region 34 and the negative electrode-side region 35, a higher percentage of the base material 33 is disposed in the intermediate region 36 than in the positive electrode-side region 34 and negative electrode-side region 35, and the binder content in the intermediate region 36 is higher than the binder content in at least one selected from the positive electrode-side region 34 and the negative electrode-side region 35.

This arrangement improves the strength of the solid electrolyte layer 30 due to the inclusion of the base material 33, while also suppressing delamination and cracking between the solid electrolyte 32 and the base material 33 due to the inclusion of the base material 33, and reducing unevenness in the strength. Accordingly, yield is improved and less material is wasted, contributing to the reduction of environmental destruction. Moreover, the suppression of delamination and cracks in the solid electrolyte layer 30 leads to improved lithium ion conductivity, and as a result, an improvement in energy efficiency is attained.

In the solid-state battery 1 according to the embodiment, the binder 40 in the solid electrolyte layer 30 preferably is such that the binder content in the negative electrode-side region 35 is higher than the binder content in the positive electrode-side region 34.

This arrangement can accommodate expansion and contraction, dendrite precipitation, and the like.

In the solid-state battery 1 according to the embodiment, preferably, the negative electrode 20 includes the negative electrode layer 21 containing the negative electrode active material disposed on the solid electrolyte layer 30 side and the negative electrode current collector 22 disposed on the surface side of the negative electrode 20, the negative electrode-side region 35 includes the first negative electrode-side region 35a located on the negative electrode current collector 22 side and the second negative electrode-side region 35b located closer to the positive electrode 10 than the first negative electrode-side region 35a, and the binder content in the first negative electrode-side region 35a is higher than the binder content in the second negative electrode-side region 35b.

With this arrangement, the binder 40 can be disposed closer to the base material 33, thereby improving the effect whereby the binder 40 suppresses delamination and cracks in the solid electrolyte layer 30.

In the solid-state battery 1 according to the embodiment, when 100% by mass is taken to mean the entirety of the solid electrolyte layer 30, the binder content for binding together the solid electrolyte material in the solid electrolyte layer 30 preferably is equal to or higher than 10% by mass.

With this arrangement, a greater quantity of the binder 40 is contained in the solid electrolyte layer 30, thereby improving the effect whereby the binder 40 suppresses delamination and cracks in the solid electrolyte layer 30.

A method of manufacturing a solid electrolyte sheet according to the embodiment is a method of manufacturing a solid electrolyte sheet containing the porous base material 33 filled with the solid electrolyte material, and the binder, the method including: a first application step of applying the binder to the base material 33; and a second application step of applying the solid electrolyte material to the base material 33.

With this arrangement, a solid-state battery exhibiting the advantageous effects described above can be manufactured favorably.

In the method of manufacturing a solid electrolyte sheet according to the embodiment, preferably, the first application step includes a step of applying to the base material 33 a first solution containing the binder and the second application step includes a step of applying to the base material 33 a second solution which contains at least the solid electrolyte 32 and which has a lower binder content than the first solution.

With this arrangement, the binder 40 can be disposed closer to the base material 33, thereby improving the effect whereby the binder 40 suppresses delamination and cracks in the solid electrolyte layer 30.

The foregoing describes a specific embodiment of the present invention, but the present invention is not limited to the above embodiment, variations, improvements, or the like are also included in the scope of the present invention insofar as the objective of the present invention can be achieved.

EXPLANATION OF REFERENCE NUMERALS

| | |
|---|---|
| 1 | solid-state battery |
| 10 | positive electrode |
| 20 | negative electrode |
| 21 | negative electrode layer |
| 22 | negative electrode current collector |
| 30 | solid electrolyte later |
| 31 | solid electrolyte sheet |
| 33 | base material |
| 34 | positivie electrode-side region |
| 35 | negative electrode-side region |
| 35 a | first negative electrode-side regio |
| 35 b | second negative electrode-side region |
| 36 | intermediate region |
| 40 | binder |

What is claimed is:

1. A solid-state battery comprising:
a positive electrode;
a negative electrode; and
a solid electrolyte layer which is disposed between the positive electrode and the negative electrode and which includes a solid electrolyte sheet containing a porous base material filled with a solid electrolyte material, and a binder, wherein
the solid electrolyte layer includes:
a positive electrode-side region that includes a region a prescribed distance from a contact surface with respect to the positive electrode,
a negative electrode-side region that includes a region a prescribed distance from a contact surface with respect to the negative electrode, and
an intermediate region located between the positive electrode-side region and the negative electrode-side region,
a higher percentage of the base material is disposed in the intermediate region than in the positive electrode-side region and negative electrode-side region, and
content of the binder in the intermediate region is higher than content of the binder in at least one selected from the positive electrode-side region and the negative electrode-side region.

2. The solid-state battery according to claim 1, wherein content of the binder in the negative electrode-side region is higher than content of the binder in the positive electrode-side region.

3. The solid-state battery according to claim 1, wherein the negative electrode includes a negative electrode layer containing a negative electrode active material disposed on a side of the solid electrolyte layer and a negative electrode current collector disposed on a surface side of the negative electrode,
the negative electrode-side region includes a first negative electrode-side region located on a side of the negative electrode current collector and a second negative electrode-side region located closer to the positive electrode than the first negative electrode-side region, and
content of the binder in the first negative electrode-side region is higher than content of the binder in the second negative electrode-side region.

4. The solid-state battery according to claim 1, wherein when 100% by mass is taken to mean an entirety of the solid electrolyte layer, content of the binder for binding together the solid electrolyte material in the solid electrolyte layer is equal to or higher than 10% by mass.

5. The solid-state battery according to claim 1, wherein the negative electrode includes, as the negative electrode active material, at least one selected from a Li-based material and a Si-based material.

6. A method of manufacturing a solid electrolyte sheet containing a porous base material filled with a solid electrolyte material, and a binder, the method comprising:
a first application step of applying the binder to the base material; and
a second application step of applying the solid electrolyte material to the base material.

7. The method of manufacturing a solid electrolyte sheet according to claim 6, wherein
the first application step includes a step of applying to the base material a first solution containing the binder, and
the second application step includes a step of applying to the base material a second solution which contains at least a solid electrolyte and which has a lower content of the binder than the first solution.

8. The solid-state battery according to claim 2, wherein when 100% by mass is taken to mean an entirety of the solid electrolyte layer, content of the binder for binding together the solid electrolyte material in the solid electrolyte layer is equal to or higher than 10% by mass.

9. The solid-state battery according to claim 2, wherein the negative electrode includes, as the negative electrode active material, at least one selected from a Li-based material and a Si-based material.
